(19) United States
(12) Patent Application Publication
(10) Pub. No.: US 2026/0116034 A1
(43) Pub. Date: Apr. 30, 2026

(54) STRUCTURE INCLUDING TESSELLATION OF UNIT CELLS INCLUDING LENS-SHAPED UNITS AND CONNECTOR UNITS

(71) Applicant: THE ROYAL INSTITUTION FOR THE ADVANCEMENT OF LEARNING/MCGILL UNIVERSITY, Montréal (CA)

(72) Inventors: Damiano PASINI, Montréal (CA); Morad MIRZAJANZADEH, Montreal (CA)

(21) Appl. No.: 19/368,610

(22) Filed: Oct. 24, 2025

Related U.S. Application Data
(60) Provisional application No. 63/711,976, filed on Oct. 25, 2024.

(51) Int. Cl. B31D 5/04; B31D 3/00

(52) U.S. Cl. CPC B31D 5/04; B31D 3/005; B31D 2205/00

(57) ABSTRACT

A structure, has: a tessellation of unit cells secured to one another, a unit cell of the unit cells including: a lens-shaped unit having first and second panels and a lens-shaped panel between the first and second panels, each of the first and second panels connected to a respective one of opposed arcuate folding edges of the lens-shaped panel; and a connector unit having a plurality of interconnected connector panels secured to the lens-shaped panel and to the first and second panels of the lens unit, wherein the unit cell has a unfolded configuration in which the lens-shaped unit and the connector unit lie in a common plane, and a locked configuration in which the first and second panels are rotated relative to the lens-shaped panel and in which the plurality of interconnected connector panels are folded into a flat configuration.

### CROSS-REFERENCES TO RELATED APPLICATIONS

The application claims benefit from U.S. provisional application No. 63/711,976 filed on Oct. 25, 2024, the entire contents of which are incorporated by reference herein.

### TECHNICAL FIELD

The application relates generally to reprogrammable material and, more particularly, to metamaterials configured to withstands loads and shape morph.

### BACKGROUND

Origami, the ancient art of paper folding, offers an elegant strategy to transform flat sheets into aesthetically appealing three-dimensional forms with remarkable properties such as programmable shape and stiffness. Most existing patterns, however, mainly rely on straight-creases, and once deployed, cannot conform to a surface with smooth curvature nor resist multi-directional forces due to their intrinsic floppiness. Improvements are thus sought.

### SUMMARY

The present disclosure introduces a class of origami metamaterials that integrates straight and curved creases into a hybrid crease pattern, reinforced by an array of tendons, to deploy into structural shells with smooth curvature, multiaxial rigidity, and tunable flexural modulus. The existence of a rigid-foldable hybrid pattern is demonstrated, and an inverse problem is solved to determine the tiling that, upon locking, conforms to prescribed smooth cylindrical and doubly-curved surfaces. By leveraging notions of tensegrity, tendons may be embedded into the floppy origami, and the incremental stretch of tendons that can impart structural rigidity and enable continuous modulation of stiffness by several orders of magnitude is demonstrated.

This disclosure pertains to origami design of smoothly-curved deployable shells with shape-adaptable structural properties, empowering diverse lightweight applications ranging from meter-scale architectural deployment on curved surfaces to wearable exoskeletons with conforming curvature, shape-adaptive fabrics, and miniature tendon-driven robots.

In one aspect, there is provided a structure, comprising: a tessellation of unit cells secured to one another, a unit cell of the unit cells including: a lens-shaped unit having first and second panels and a lens-shaped panel between the first and second panels, each of the first and second panels hingedly connected to a respective one of opposed arcuate folding edges of the lens-shaped panel; and a connector unit having interconnected connector panels secured to the lens-shaped panel and to the first and second panels of the lens unit, wherein the unit cell has: an unfolded configuration in which the lens-shaped unit and the connector unit lie in a common plane, and a locked configuration in which the first and second panels are rotated relative to the lens-shaped panel about the opposed arcuate folding edges and extend transversally to the lens-shaped panel, and in which the interconnected connector panels are folded into a flat configuration and extend transversally to the first and second panels and the lens-shaped panel of the lens-shaped unit.

The structure described above may include any of the following features, in any combinations.

In some embodiments, the connector unit is a waterbomb connector.

In some embodiments, the lens panel defines two symmetry plane being normal to one another.

In some embodiments, the lens-shaped unit folds symmetrically with respect to a symmetry plane of the lens-shaped panel such that the first panel faces the second panel.

In some embodiments, the tessellation of the unit cells includes at least one row of the unit cells extending along a longitudinal axis.

In some embodiments, the structure includes tendons interconnecting the unit cells and maintaining the unit cells in the locked configuration.

In some embodiments, the tendons include a first tendon interconnecting together all of the connectors units to maintain the connector units in a folded configuration, the first tendon configured to impart flexural stiffness to the tessellation by opposing a flexion force exerted along a direction transverse to the lens-shape panel of one of the unit cells.

In some embodiments, the first tendon extends along the longitudinal axis and through the connector units, the first tendon extending along symmetry planes of the lens-shaped panels and proximate the lens-shaped panels.

In some embodiments, in the locked configuration, the tessellation defines boxes having an opening defined by the first and second panels of the lens unit and by connector units, the structure further comprising: a second tendon that extends diagonally across the opening and that interconnect a first connector unit to a second connector unit, the second tendon configured to impart one or more of torsional and bending stiffness to the tessellation by opposing one or more of a first torsional moment exerted to the tessellation in a first direction around the longitudinal axis and a force exerted along a direction transverse to the first panel of one of the unit cells.

In some embodiments, the structure includes: a third tendon that extends diagonally across the opening and transversally to the second tendon, the third tendon interconnecting the first connector unit to the second connector unit, the third tendon configured to impart one or more of torsional and bending stiffness to the tessellation by opposing one or more of a second torsional moment exerted to the tessellation in a second direction opposed to the first direction and a force exerted along a direction transverse to the second panel of one of the unit cells.

In some embodiments, the connector unit is connected to the lens-shaped panel via a lens edge, to the first panel via a first edge, and to the second panel via a second edge, the first edge extending from a first proximal end at a first intersection with the lens-shaped panel to a first distal end, the second edge extending from a second proximal end at a second intersection with the lens-shaped panel to a second distal end, the second tendon interconnecting the first distal end to a second distal end of an adjacent connector unit.

In some embodiments, the third tendon interconnects the second distal end to a first distal end of the adjacent connector unit.

In some embodiments, the lens panel defines a single symmetry plane, the first and second panels located on respective opposite sides of the single symmetry plane.

In some embodiments, the unit cells include a first unit cell and a second unit cell, a first area covered by the first unit cell different than a second area covered by the second unit cell.

In some embodiments, the tessellation, in the locked configuration, defines a doubly-curved surface, the doubly-curved surface defining a curvature in two directions perpendicular to one another.

In some embodiments, the structure includes a tensioning mechanisms to impart tension in the tendons.

In some embodiments, the structure is one of a wheel, an antenna, a helmet, an exoskeleton, and a tent.

In another aspect, there is provided a method of manufacturing a structure using interconnected unit cells, comprising: obtaining characteristics of a target shape; solving an inverse problem to determine dimensions of unit cells to be tessellated to define the structure, a unit cell of the unit cells having a lens-shaped unit including first and second panels and a lens-shaped panel between the first and second panels, each of the first and second panels hingedly connected to a respective one of opposed arcuate folding edges of the lens-shaped panel, a connector unit having interconnected connector panels secured to the lens-shaped panel and to the first and second panels of the lens unit; manufacturing the unit cells per the dimensions; folding the unit cells in a locked configuration such that the first and second panels are rotated relative to the lens-shaped panel about the opposed arcuate folding edges and extend transversally to the lens-shaped panel, and such that the interconnected connector panels are folded into a flat configuration and extend transversally to the first and second panels and the lens-shaped panel of the lens-shaped unit; and assembling the unit cells to obtain the structure having the target shape.

The method of manufacturing a structure using interconnected unit cells described above may include any of the following features, in any combinations.

In some embodiments, the solving of the inverse problem to determine the dimensions of the unit cells include determining lengths of the arcuate folding edges.

In some embodiments, the assembly of the unit cells includes interconnect the unit cells with tendons to impart one or more of flexural stiffness and torsional stiffness.

### BRIEF DESCRIPTION OF THE DRAWINGS

Reference is now made to the accompanying figures in which:

FIG. 1A is a plan view of a tessellation of a symmetric waterbomb lens-box unit;

FIG. 1B is a three-dimensional view of the tessellation of FIG. 1A shown in a partially folded configuration;

FIG. 1C is a three-dimensional view of the tessellation of FIG. 1B shown in a locked configuration;

FIG. 1D is a plan view of a lens-unit of the tessellation of FIG. 1A in its unfolded configuration;

FIG. 1E are top, side, and cutaway views of the lens-unit of FIG. 1D shown in its partially folded configuration;

FIG. 1F is a series of three-dimensional views of a connector unit of the lens-box unit of FIG. 1A and illustrating a folding sequence thereof;

FIG. 1G is a series of three-dimensional views illustrating a folding sequence of the lens-box unit of FIG. 1A;

FIG. 1H is a plan view of a tessellation of a doubly curved lens-box tessellation;

FIG. 1I is a plan view of a lens-unit of the tessellation of FIG. 1H in its unfolded configuration;

FIG. 1J are three dimensional views of the lens-unit of FIG. 1H shown in partially folded and locked configurations;

FIGS. 2A to 2G are three-dimensional views of exemplary tessellations manufactured with the lens-box cell units of FIG. 1A;

FIG. 3A is a plan view of a tessellation in accordance with another embodiment;

FIG. 3B are views of the tessellation of FIG. 3A shown in a locked configuration and illustrating its behaviour when subjected to compression or flexion forces;

FIG. 3C are views of the tessellation of FIG. 3A in a locked configuration and illustrating its behaviour when subjected to torsion and lateral flexion forces;

FIG. 3D is a three-dimensional view of a tessellation in accordance with another embodiment using tendons to impart rigidity to the tessellation, the tessellation illustrated in a partially folded configuration;

FIG. 3E is a three dimensional view of the tessellation of FIG. 3D in a locked configuration;

FIG. 3F are three dimensional views of a tessellation in accordance with yet another embodiment with and without the use of tendons to impart rigidity;

FIG. 4A are three dimensional views of a tessellation in accordance with another embodiment in both soft and load-bearing configurations;

FIG. 4B is a graph illustrating a variation of a displacement as a function of a force applied to the tessellation of FIG. 4A;

FIG. 4C is a graph illustrating an apparent elastic flexural modulus B* as a function of tendon pre-tenson T;

FIG. 4D are three dimensional views of the tessellation of FIG. 4A, the rigidity being imparted by the tendons;

FIG. 4E are three dimensional views of the tessellation of FIG. 4A, the rigidity being imparted by glue;

FIGS. 4F-4G are three dimensional views of a tessellation shown in floppy configurations;

FIG. 4H illustrates the tessellation of FIG. 4F in various stable configurations and deployment stages from loose into a pre-defined arc;

FIGS. 5A to 5F are three dimensional views of a metamaterial in accordance with one embodiment and of a tensioning mechanism in accordance with one embodiment to impart tensions in tendons of the metamaterial;

FIGS. 6A to 6D are schematic views of objects including the tessellations described above; and

FIG. 7 is a flowchart illustrating steps of a method of manufacturing a structure.

### DETAILED DESCRIPTION

### Introduction

Rigid, smoothly curved surfaces are used in science and engineering, impacting fields from aerospace and product design to optics and biomechanics. Embedded into a material, a curved surface often needs to reconcile antagonist functions, such as adapting its shape and/or properties without compromising rigidity. This trade-off is a currently unmet challenge in existing metamaterials across disciplines from wearable medical supports, soft robotics, adaptive fabrics and exoskeletons, to deployable solar sails and antennas.

A material that needs to be dynamically shaped into a smoothly curved surface often requires reconciling antagonistic functions, such as morphing its shape and/or adapting its properties without compromising rigidity and smoothness in the deployed state. Typically, the trade-off between rigidity, curvature smoothness, and property tunability cannot be attained in current technology, including wearable supports and exoskeletons, deployable orthopedic implants, soft robotics, and deployable solar sails or antennas. Soft robotic metamaterials, for instance, often rely on either inflatable systems with soft skins or origami structures featuring jagged, corrugated textures. The former lacks surface rigidity, whereas the latter lacks surface smoothness. Soft skins are also vulnerable to abrasion in rough environments, such as those encountered in planetary exploration. Additionally, jagged surfaces are unsuitable for applications requiring low friction for drag reduction, for example, in swimming robots. Moreover, conformal curved contours are often desired in orthopedic implants to match the complex geometries of curved bones. While recent origami-based deployable implants have enabled compact insertion and in situ expansion, their designs typically deploy into faceted forms that cannot form smooth, doubly curved geometries—a critical requirement for conformal, load-bearing integration of implants in complex anatomical sites.

Similar challenges arise in wearable assistive technology and exoskeletons, which must conform to the curved shape of the human body while providing structural support. Existing concepts, on the other hand, often rely on discrete folds or rigid, chainmail-like elements, resulting in non-smooth surfaces that can cause discomfort or even pain during prolonged wear or when compressed against the body. Currently, a technology that can deploy into a shell tessellation with a smoothly curved surface and tunable load-bearing capacity remains an unresolved challenge across various domains.

In the context of the present disclosure, the expression “load-bearing capacity” relates to the ability of a structure to support a load beyond its own weight. The load-bearing capacity may be direction-dependent and is therefore defined with respect to the loading mode and direction (e.g., in-plane or out-of-plane compression, tension, shear, bending, or multiaxial states), the loading rate (quasi-static or dynamic), boundary conditions, and environmental conditions.

The present disclosure presents a hybrid curved-straight crease pattern, geometrically constructed to enable tiling into cylindrical surfaces with a prescribed global curvature of constant value. The intrinsic nature of this pattern and its kinematic constraints, however, make it challenging to generate smooth doubly-curved surfaces, fold into shapes with varying curvature, and deploy structural shells with reprogrammable flexural rigidity. These properties have significant implications that are important in a broad range of applications, such as doubly curved antenna reflectors for space, tunable and deployable curved structures, ergonomically shaped exoskeletons and wearables, aerodynamically shaped bodies for automotive and aerospace, and reconfigurable doubly curved soft robots with adaptive variable curvature.

In the context of the present disclosure, the expression “doubly-curved” refers to a surface having curvature in two mutually perpendicular directions such that both principal curvatures at a given point on the surface are non-zero. In certain embodiments, the doubly curved surface may exhibit positive Gaussian curvature (e.g., convex or concave forms such as a spherical or ellipsoidal surface) or negative Gaussian curvature (e.g., saddle-shaped or hyperbolic surfaces). A doubly curved surface thereby differs from a singly curved surface, such as a cylindrical surface, which has curvature in only one direction.

Origami principles may offer a promising solution for creating deployable shells with desired curvature at multiple length scales. Existing concepts, however, are typically floppy under mechanical loads and rely on straight-crease patterns to deploy into a piecewise linear approximation of curvature, with precision dependent on the pattern size. Reducing the crease patterns' dimension inevitably lowers the origami shells' thickness, making them even more floppy since flexural rigidity scales cubically with the shell thickness, thus posing an antagonism between smoothness approximation and load-bearing capacity. While curved creases can produce smoothly curved surfaces, they have primarily been used in non-structural applications and art. Tiled patterns that fold into smooth yet load-bearing shells remain an elusive concept in origami.

One strategy for generating stiffness in deployable structures is to systematically integrate a network of pre-stretched tendons that partially or fully constrain the folding degrees of freedom, akin to cables in a structural tensegrity system. Cables may be employed to control folded geometry or induce mechanical bistability in origami structures. Tensegrity principles may be effective for enhancing the axial stiffness during the deployment of single-degree-of-freedom, collapsible, straight-crease origami structures. Most of them feature unidirectionally tiled, rigid-foldable origami patterns, which primarily resist compression and tension only. These concepts, however, cannot be easily extended to in-plane origami tessellations made of bendable panels, which can fold into shell structures capable of resisting bending actions and multiaxial forces, a common scenario encountered in everyday technology.

The tendons are thus substantially non-extensible along their length to impart stiffness to the tessellation. It will be appreciated that the expression “substantially” implies that some degree of extension is possible, although it is minimal and may be unnoticeable to the naked eye.

In a first aspect of the present disclosure, a ‘lens-box’ is introduced. The lens-box is a lockable and rigid-foldable hybrid crease pattern that, once locked, conforms to smoothly curved surfaces. Unlike existing concepts that are floppy, the disclosed lens-box is supplemented with an array of tendons that can stiffen the folded pattern by contraction, resembling the tightening of myofibrils in muscle cells and reminiscent of strings in a tensegrity system. The tendons guide folding and enable the underlying folded pattern to shift reversibly and continuously from a relaxed configuration to a rigid, multiaxially load-bearing state. This evokes phase transformation in solids, where the amount of tendon stretching, as opposed to the transition temperature, governs folding and property tunability—a process that squeezes adjacent building blocks in a manner analogous to jamming transition. The concept introduced in this disclosure, on the other hand, does not rely on gravity, air pressure, and environmental stimuli.

In a second aspect of the present disclosure, a doubly curved lens-box is introduced. The doubly curved lens-box is a lockable and rigid-foldable hybrid crease pattern that combines curved and straight creases. Once deployed in its locked state, its tessellated pattern conforms to a doubly curved surface which is smooth in one direction and piecewise linear in the other. Unlike existing concepts that are floppy, the doubly curved lens-box is supplemented with an array of tendons, here denoting cable-like elements that resist extension only. These tendons can stiffen the folded pattern by contraction, reminiscent of cables in a tensegrity structure. Since the origami building block tessellates into a smooth, continuous surface, the resulting origami shell forms a periodic metamaterial whose effective properties can be tailored via geometric design and actively reprogrammed through tendon pre-tension post fabrication. The tendons guide folding and enable the underlying folded pattern to shift reversibly and continuously from a relaxed configuration to a rigid, multiaxially load-bearing state. This evokes phase transformation in solids, where the amount of tendon stretching, as opposed to the transition temperature, governs folding and property tunability—a process that squeezes adjacent building blocks in a manner analogous to jamming transition. The concept introduced in this work, on the other hand, does not rely on gravity, fluid pressure, and environmental stimuli.

### Cell Unit—Lens-Box

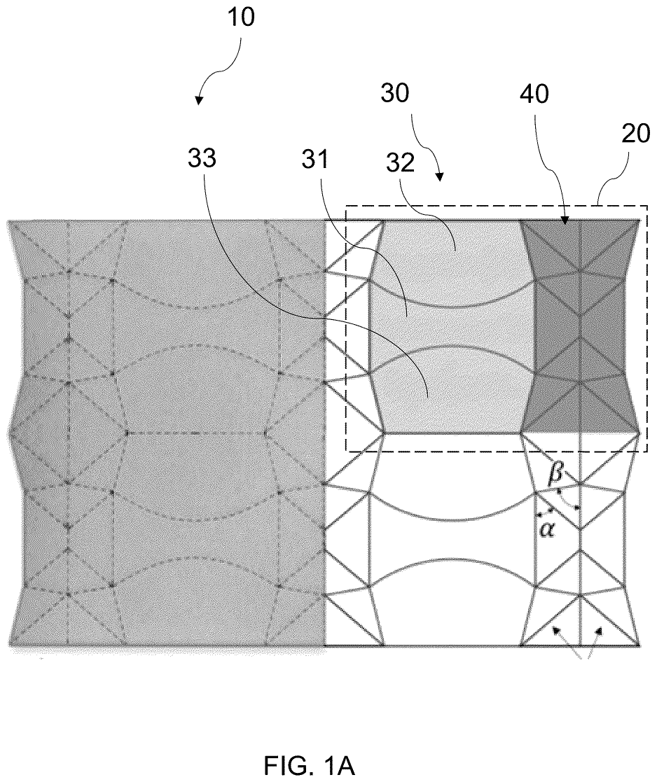

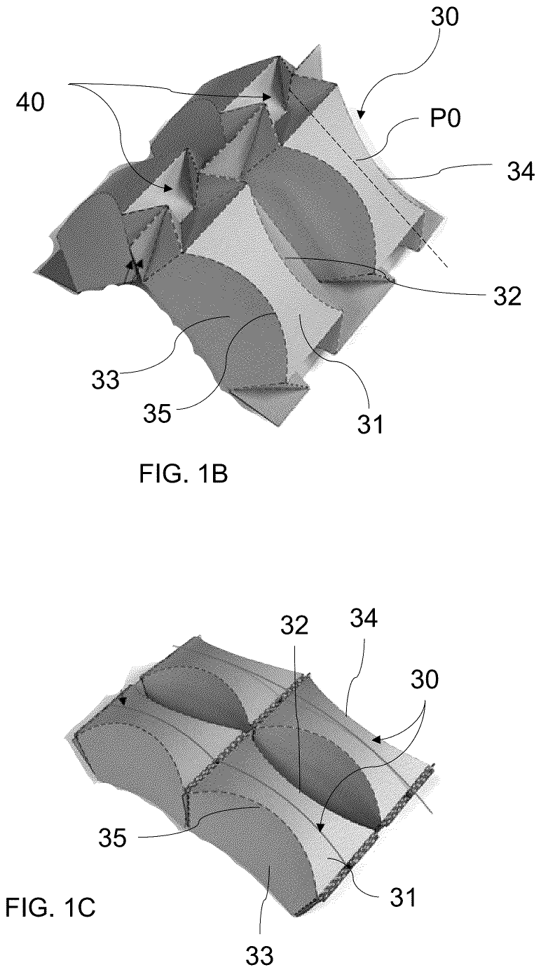

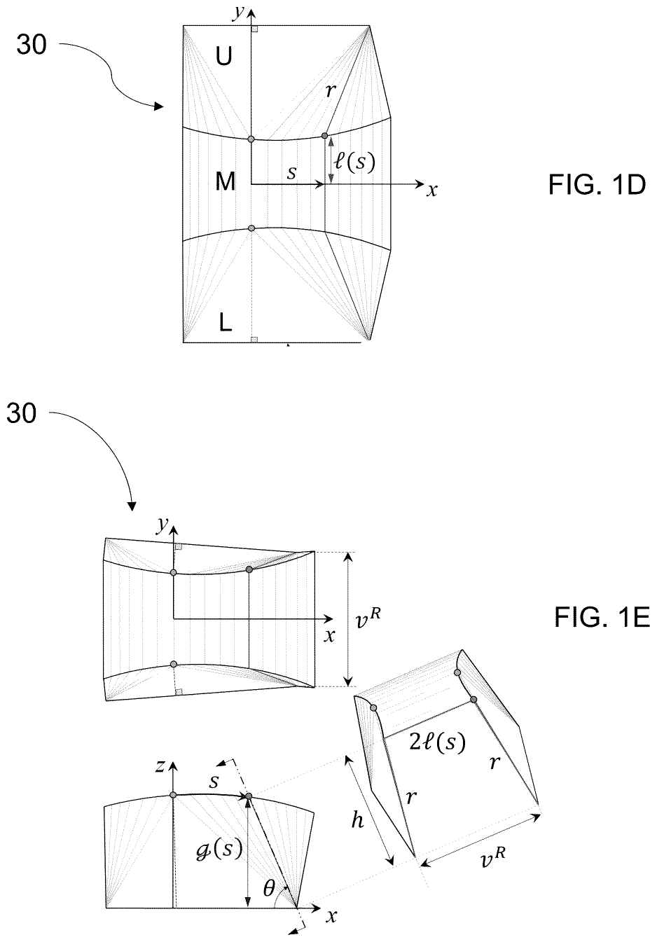

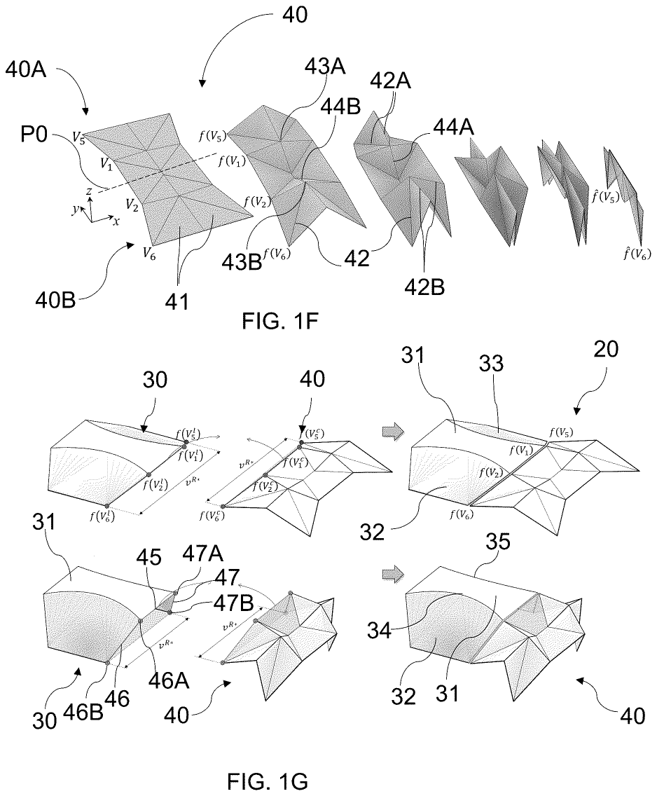

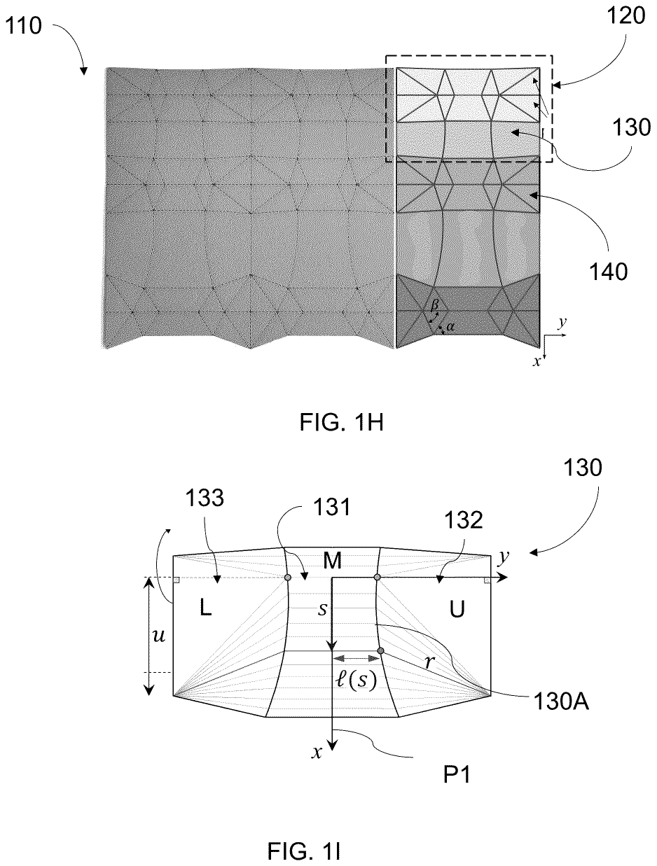

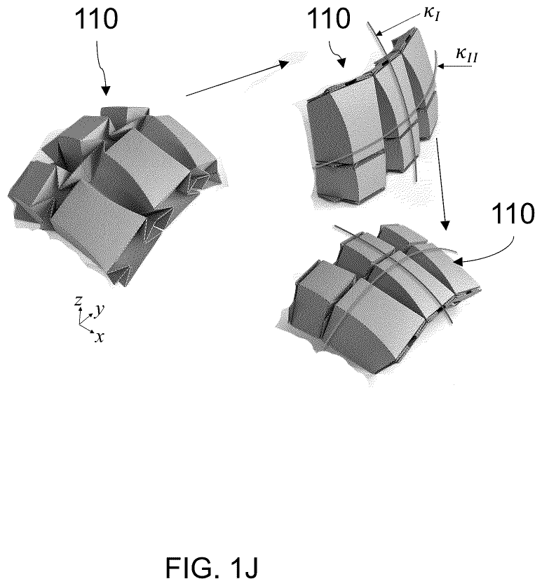

Referring to FIG. 1A, a plan view of a metamaterial including a tessellation is shown at 10. The tessellation 10 includes a plurality of unit cells 20, herein a matrix of 2×2 unit cells 20, connected together. It will be appreciated that the tessellation may include any suitable number of unit cells. One of the unit cells 20 is shown encircled with dashed lines. The unit cell 20 may be referred to as a lens-box unit cell. In the embodiment shown, the lens-box unit cell 20 comprises two distinct yet complementary building blocks: a curved-crease lens unit, referred to below as a lens unit 30 resembling a lens shape, and a flat-foldable straight-crease waterbomb connector, referred to below as a connector unit 40, that joins the straight creases of adjacent lens units 30 together.

Each lens unit 30 consists of two symmetric curved arcs enclosing a middle ‘lens panel’ 31, separating an upper ‘leg panel’ referred to as a first panel 32 from a lower ‘leg panel’ referred to as a second panel 33. The hybrid-crease unit cell, formed by merging lens unit 30 and waterbomb connector 40, can tile the entire plane. Upon folding, their shared linear edges form straight creases, whereas their two-dimensional arc creases deploy into their three-dimensional curved counterpart, forming an array of out-of-plane arched surfaces.

Referring more particularly to FIGS. 1B and 1C, the lens unit 30 is described in more detail. In the embodiment shown, the lens unit 30 includes two opposed arcuate edges 34, 35. The first panel 32 is pivotable relative to the lens panel 31 about a first actuate edge 34 whereas the second panel 33 is pivotable relative to the lens panel 31 about a second arcuate edge 35.

The first and second arcuate edges 34, 35 extend towards one another. Put differently, they define a concave shape. The lens-shaped unit folds symmetrically with respect to a symmetry plane P0 of the lens-shaped panel 31 such that the first panel faces the second panel. In the folded, or locked configuration depicted in FIG. 1C, the first and second panels 32, 33 extend transversally to the lens-shaped panel 31.

To understand the folding kinematics of the pattern, its deformation may be idealized. A straight-crease pattern folds through the mere rotation of its hinges (creases) without flexing its faces, a property known as rigid-foldability. In contrast, folding a curved-crease pattern requires the additional deflection of its panels. For developable curved-crease lens units, a sheet of vanishing thickness deforms only through bending is assumed. This is underpinned by the energy scaling law: the stretching energy scales with the panel thickness t, while the bending energy scales with t\hat{ }3, making bending the dominant form of deformation. This assumption enables to describe the kinematic of the lens unit by segmenting each curved panel into a non-crossing ruled surface, forming the rulings, a family of rule segments. If the rulings remain unaltered upon folding, the curved-crease is rigid-foldable. Proving the existence of a unique ruling pattern is essential to describing folding and achieving rigid-foldability, enabling even non-deformable materials to form curved panels.

The existence of a unique ruling pattern and the folded geometry (FIGS. 1D-1E) has been developed using theories of general curved-crease folding and differential geometry under certain assumptions. It is assumed that folding mapping is isometric, i.e., a length-preserving transformation, with no twisting deformation in the lens panel. The rulings within the lens panel are thus parallel segments, and the geometry of the folded lens unit remains symmetric with respect to the plane bisecting. Additionally, it is assumed that curved creases fold smoothly, generating surfaces with C continuity (second derivative) and kink-free folded creases.

The folded geometry of the generalized lens unit is constructed by establishing the relations between pairs of points on creases connected through rule segments. The unfolded (flat) C curved-crease arc is denoted by the parametric function I(s), where s measures the x-coordinate of the crease point. The ‘folding parameter’ v\hat{ }R, which measures the distance between the apices of the right cone-ruled segments of the upper and lower panels is introduced. Using I(s) and v\hat{ }R, along with a set of parameters defining the unfolded lens-unit geometry, it is possible to explicitly correlate I to the orthogonal projection of the folded panel onto the xz-plane, represented by the parametric function g(s), where s is the arc length. This correlation allows for the derivation of a complementary relation that specifies the necessary condition for the smooth folding of the curved crease. Since the folding parameter v\hat{ }R is the only independent parameter governing folding, the lens unit has one degree-of-freedom (DOF).

### Rigid Foldability and Locking

Having described the geometry of a 1-DOF rigid-foldable lens unit, the folding of the connector and the entire pattern is discussed. The connector may be also rigid-foldable with 3-DOF, similar to the original waterbomb pattern. This can reduce to either 2-DOF with symmetric folding or 1-DOF when its tail panels come into contact at a specific folding state. Once the connector flat-folds fully, the lens unit can no longer fold as it has reached a lock state or configuration as shown in FIG. 1C. While local flat-foldability can be verified using Kawasaki's and Maekawa's Theorems, these are insufficient for assessing global flat-foldability in the 4-vertex connector unit. To design a flat-foldable connector, the flat-folded state may be geometrically constructed and constraints that prevent edge and vertex penetrations may be derived. Satisfying these flat-foldability conditions may also ensure its full-range rigid folding motion.

Assessing the rigid foldability of a multi-vertex pattern such as the lens-box tessellation is NP-hard. Here, it is only possible to prove the rigid-foldability of a single lens-box unit and its unidirectional tessellations. In particular, Freeform rigid origami simulations may be used to demonstrate that the pattern remains rigid-foldable once tessellated in plane. While it may not be possible to study it through rigid-folding simulations, in practice, it is realised that folding the tessellated pattern becomes more difficult as the sector angle β in the waterbomb connector approaches the sector angle α.

Referring to FIGS. 1F and 1G, the folding sequence of the connector unit 40 and of the unit cell 20 are illustrated.

The ‘waterbomb connector’, referred to as the connector unit 40, in the lens box pattern plays a twofold role. First, it contributes to the overall pattern folding by acting as a rigid-foldable mechanism; second, it interfaces two lens units 30. If two waterbomb connectors one on the right hand side of the lens unit and the other on left hand side of the lens unit are considered, the governing mechanism of the lens-box pattern which possesses a lock configuration, beyond which no further folding is possible due to the contact of the waterbomb panels may be obtained; at this state the waterbomb connector is flat-folded. Since the lens-box unit must be developable, rigidly foldable, and lockable, geometrical congruence between the lens unit and the adjacent waterbomb connectors across the entire rigid folding is required, from the unfolded flat state to the lock configuration.

As one may appreciate from FIG. 1F, the connector unit 40 has a folded configuration in which a plurality of interconnected connector panels are folded into a flat configuration and extend transversally to the first and second panels 32, 33 and the lens-shaped panel 31 of the lens unit 30. It has been shown that the general waterbomb pattern consisting of a series of degree-6 vertices (where six creases meet), is rigidly foldable with multiple DOFs, which can be reduced to one if the pattern folds symmetrically with respect to its bisecting yz-plane. In contrast, the disclosed waterbomb pattern consists of a single cell only which is not laterally confined by other waterbomb units. Hence upon assuming symmetric folding rigid-foldability, the connectors may have 2-DOF. The connector unit 40 is rigid-foldable, that is, it folds through the sole rotation of its creases without facet deformation.

As shown in FIG. 1F, the connector unit 40 includes a plurality of interconnect panels 41 that are hingedly connected to one another at respective interconnected edges 42. These edges 42 may be referred to as living hinges since it permits the pivotal connection of two adjacent panels 41 via deformation of a material interconnecting them. In some embodiments, separate hinges may be used. The connector 40 shares the same symmetry plane P0 as the lens unit 30. The connector unit 40 may thus have two halves 40A, 40B each disposed on a respective one of opposite sides of the symmetry plane P0. Each of the two halves 40A, 40B include a central vertices 43A, 43B and a plurality of edges 42A, 42B extending from the central vertices 43A, 43B. The panels 41 of each of the two halves 40A, 40B fold such that the edges 42A, 42B define crests and valleys distributed around the central vertices 43A, 43B. Then, central edges 44A, 44B of the edges 42A, 42B define crests and are folded towards one another thereby causing the collapsing of the panels 41 into a flat configuration in which they lie parallel to one another.

As shown in FIG. 1G, when the connector unit 40 is attached to a lens unit 30, the folding of the connector unit 40 as explained above causes the lens unit 30 to fold by rotating the first and second panels 32, 33 about the arcuate edges 34, 35 and relative to the lens-shaped panel 31. The first and second panels 32, 33 rotate in opposite directions such that they move towards one another during the folding of the lens unit 30.

As shown in FIG. 1G, the connector unit 40 is connected to the lens-shaped panel via a lens edge 45, to the first panel via a first edge 46, and to the second panel via a second edge 47. The first edge 46 extends from a first proximal end 46A at a first intersection with the lens-shaped panel 31 to a first distal end 46B and the second edge 47 extends from a second proximal end 47A at a second intersection with the lens-shaped panel 31 to a second distal end 47B. The first and second distal ends 46B, 47B are located at intersections between the connector unit 40 and the first and second panels 32, 33 at opposite ends of the first and second edges 46, 47.

### Cell Unit—Doubly Curved Lens Box

Referring to FIGS. 1H and 1I, the doubly-curved lens box is shown and indicated at 120 (dashed rectangle in FIG. 1H) and being part of a tessellation denoted at 110. The tessellation 110 including a doubly curved lens-box origami pattern comprises two types of distinct yet complementary building blocks: curved-crease lens units 130, which resemble a lens shape, and flat-foldable straight-crease waterbomb connector units 140, which join the straight creases of adjacent lens units 130.

Referring to FIG. 1I, one of the lens unit 130 is described in greater detail. The lens unit 130 consists of two reflected, non-symmetric curved arcs 130A enclosing a middle lens panel 131, separating an upper leg panel, also referred to as a first panel 132 from a lower leg panel, also referred to as a second panel 133. The lens unit 130 may have a single symmetry plane P1 (FIG. 1I) extending through a center of the lens panel 131 such that the first and second panels 132, 133 are each disposed on a respective side of the single symmetry plane P1. This contrasts the lens unit 30 of FIG. 1A that includes two symmetry planes.

The tessellation 110 includes hybrid-crease unit cells—formed by merging lens-units and two dissimilar-size waterbomb connectors—to tile the entire plane. Upon folding, their shared linear edges form straight creases, whereas the two-dimensional arc creases 130A deploy into their three-dimensional curved counterparts, generating an array of out-of-plane arched surfaces joined by flat panels. As shown in FIG. 1J, at a specific folding configuration—when the facets of each connector unit 140 become coplanar (i.e., flat-folded)—the origami reaches a locked state. The geometric interplay between connectors 140 and lens units 130 of varying sizes and shapes yields a doubly curved tessellated surface that can be smooth along the lens direction K1 and a piecewise-linear approximation of uniform curvature along an orthogonal direction K2. It may also enable the formation of variable curvature geometries. In the context of the present disclosure, the expression “coplanar” when referring to the panels of the waterbomb connector implies that the panels are contacting each other. They may be offset from each other by a thickness of these panels.

To understand the folding kinematics of the doubly curved pattern, its deformation may be idealized. A straight-crease pattern folds through the mere rotation of its hinges (creases) without flexing its faces, a property known as rigid-foldability. In contrast, folding a curved-crease pattern requires the additional deflection of its panels. For developable curved-crease lens units, it is possible to assume a sheet of vanishing thickness deforms only through bending. This is underpinned by the energy scaling law: the stretching energy scales with the panel thickness t, while the bending energy scales with t\hat{ }3, making bending the dominant form of deformation. This assumption enables the description of the kinematic of the lens unit by segmenting each curved panel into a non-crossing ruled surface (FIG. 1I), forming the rulings, a family of rule segments. If the rulings remain unaltered during the entire folding process, the curved-crease is rigid-foldable. To distinguish this from the rigid-foldability definition used in straight-crease origami, it is possible to refer to it as ‘rigid-ruling foldability’. Proving the existence of an invariant ruling pattern is essential for describing folding and achieving rigid-ruling foldability. This property has significant implications as it enables the use of even non-deformable materials to create rigid-foldable origami structures that transition from a flat state to a locked, approximately curved shape.

The existence of the ruling pattern and the folded geometry may be demonstrated using theories of general curved-crease folding, insights into the ruling segmentation. Folding mapping may be assumed to be isometric, i.e., a length-preserving transformation, with no twisting deformation in the lens panel. The rulings within the lens panel are thus parallel segments, and the geometry of the folded lens unit remains symmetric with respect to the plane bisecting the lens panel. Additionally, it may be assumed that curved creases fold smoothly, generating surfaces with C2 continuity (second derivative) and kink-free folded creases. This assumption is justified by the energetic cost of non-smooth folding, which would require the formation of kinks or additional creases. These configurations are less energetically favorable because the bending energy required for smooth folding is much lower than the stretching energy needed to create kinks or new creases.

The folded geometry of the generalized lens unit is constructed by establishing the relations between pairs of points on creases connected through rule segments. The unfolded (flat) C² curved-crease arc is denoted by the parametric function [symbol] (s), where s corresponds to the x-coordinate of the crease point. A folding parameter v^{R}, which measures the distance between the apices of the right cone-ruled segments of the first and second panels 132, 133 in the folded state, and denote the x-coordinate of the corresponding cone apices in the unfolded state as u. Let μ(v^{R}) denote the angle between the base edge of the lower leg panel—treated as a directed vector from its left endpoint to its right endpoint—and the positive x-axis in the folded state, measured counterclockwise as positive. Denoting the orthogonal projection of the folded lens panel onto the xz-plane by the parametric function [symbol] (s)—where s now represents the arc length—we derive the fundamental geometric constraint that governs the smooth folding of the curved crease (see supplementary materials, section 2.1.1) as

$$\frac{{ℓ}^{′} ( 0 ) + ( \frac{{v}^{R}}{2} - ℓ ( 0 ) - u sin μ ) {ℊ}^{′} ( 0 ) / ℊ ( 0 ) {cos}^{2} μ}{\sqrt{1 - {{ℊ}^{′} ( 0 )}^{2}}} + tan μ = 0 .$$

Furthermore, [symbol] (s) can be explicitly expressed as a function of the unfolded crease [symbol] (s), allowing the entire folded geometry to be described through a single independent folding parameter (v^{R}). Hence, the lens unit exhibits a single degree of freedom (DOF).

### Rigid-Foldability and Locking

Having described the geometry of the 1-DOF rigid-ruling foldable lens unit, the folding of the connector and the entire pattern is now discussed. The connector is also shown to be rigid-foldable with 3-DOF, similar to the original waterbomb pattern. This can reduce to either 2-DOF with symmetric folding or 1-DOF when its tail panels come into contact at a specific folding state. Once the connector flat-folds fully, the lens unit can no longer fold as it has reached a locked state. While local flat-foldability can be verified using Kawasaki's and Maekawa's Theorems, these are insufficient for assessing global flat-foldability in the 4-vertex connector unit. To design a flat-foldable connector, its flat-folded state is geometrically constructed, and constraints are derived that prevent edge and vertex penetrations. Satisfying these flat-foldability conditions also ensures its full-range rigid folding motion.

Assessing the rigid-foldability of a multi-vertex pattern such as the doubly curved lens-box tessellation is NP-hard. Here, only the rigid-ruling foldability of a single doubly curved lens-box unit and its unidirectional tessellations may be proven. In particular, freeform rigid origami simulations may be used to demonstrate that the pattern remains rigid-ruling foldable once tessellated in plane. To achieve this, the curved-crease fold pattern is first approximated with a piecewise linear version consisting of a finite number of ruling segments, forming a discrete ruled surface. While the mobility of the resulting pattern remains independent of the ruling discretization, its folded geometry converges to the smoothly folded curved-crease shape as the number of ruling segments increases.

Locking into Smoothly Curved Surfaces

With the geometric construction described above, a more interesting question is addressed: Given a smooth 3D surface Ω, is it possible to find a 2D lens-box tessellation, and a 2D doubly curved lens-box, that, upon locking, can be isometrically embedded onto Ω while maintaining C¹ or C² smoothness along one principal direction? This is equivalent to finding a locked pattern where the lens panel conforms to a given meridional curvature K_{I}=1/R_{GI}≡1/R_{c} (the curvature of [symbol] ), and its tessellation along the azimuthal direction approximates a given curvature K_{II}=1/R^{GII} in a piecewise linear manner. This problem is explicitly formulated as an inverse problem that can be solved through constrained optimization. Constraints for the lens unit involve smooth folding of the crease and C¹ smoothness along the meridional direction for two adjacent units. For the connector, constraints include achieving flat-foldability without overlap or collision, and preventing panel protrusion beyond the target surface. Additionally, the effect of panel thickness is considered when matching the meridional curvature, as flat-folded connectors typically have a non-negligible thickness of ˜8t.

While the formulation can determine tessellations that conform to double-curvature surfaces, convergence can be challenging. An alternative strategy has been developed to tackle this problem: an explicit, additive tessellation approach resembling a layer-by-layer 3D printing fabrication. The generator curve of the given surface may be partitioned into sections of constant curvature. Initially, a layer of the locked units that matches the specified surface curvatures, K_{I} and K_{II} is constructed. Subsequent layers are then independently constructed using the geometry established in the preceding layer. In contrast to double-curvature surfaces, cylindrical surfaces can be tessellated with a single continuous pattern. As a result, the unfolded crease patterns for each layer remain separate (disconnected) but can be connected to neighboring layers along the meridional direction once locked. In contrast to double-curvature surfaces, cylindrical surfaces can be fabricated by folding a single, continuous sheet of paper with a tessellated pattern, whose unit cells remain seamlessly connected throughout the entire folding process, from the unfolded to the locked state.

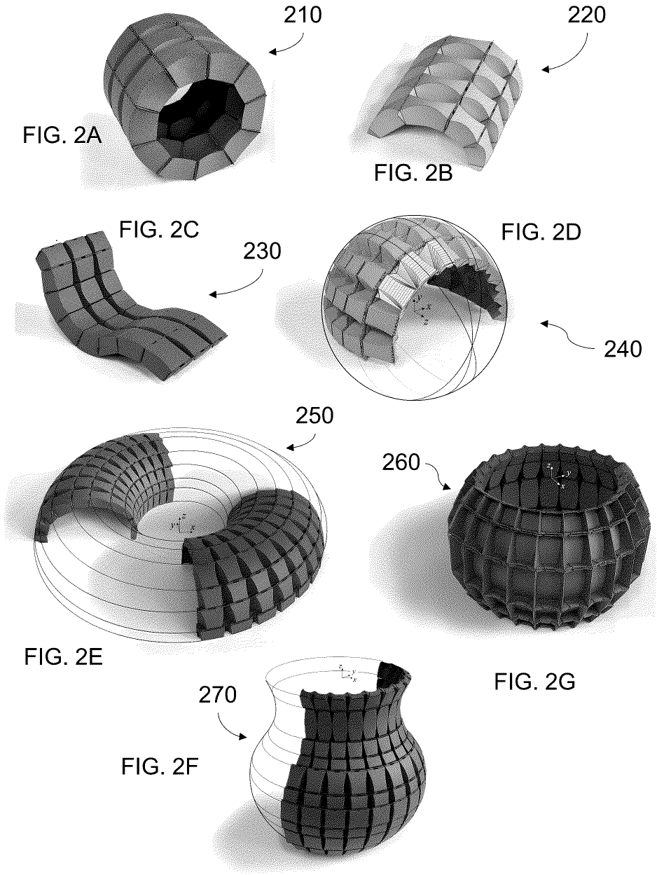

Referring to FIGS. 2A to 2G, the versatility of the disclosed approach is showcased with closed-form relations enabling various cylindrical surfaces, including a closing ring 210 (FIG. 2A), logarithmic spiral 220 (FIG. 2B), and a chair-like form 230 (FIG. 2C), as well as other non-C1 periodic tessellations 240, 250, 260, 270. FIGS. 2A to 2G show the results of the analysis applied to a geometrically diverse set of cylindrical and doubly-curved surfaces, with paperboard prototypes fabricated through laser perforation and manual folding.

### Tendons

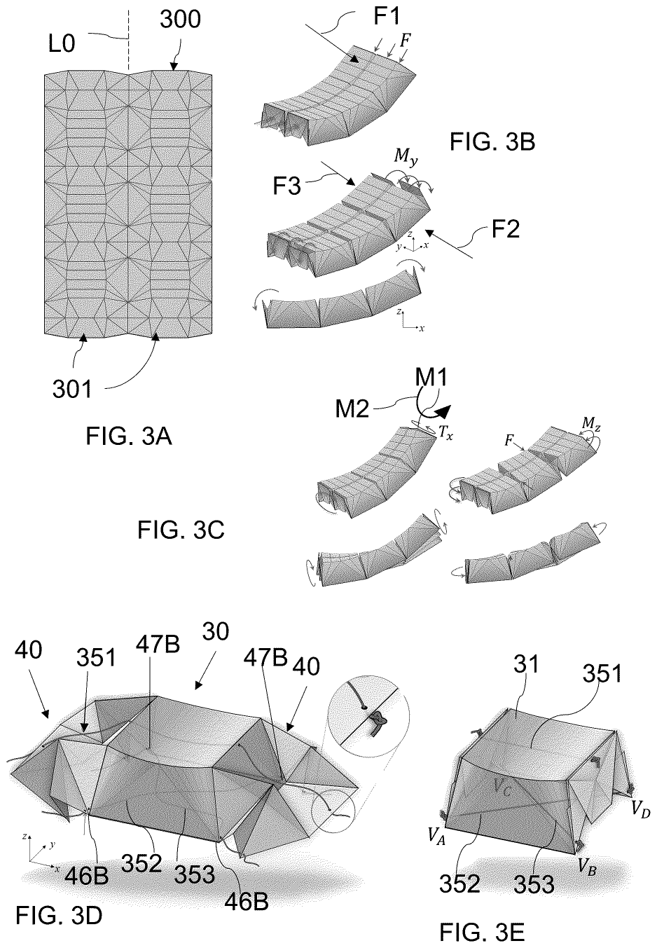

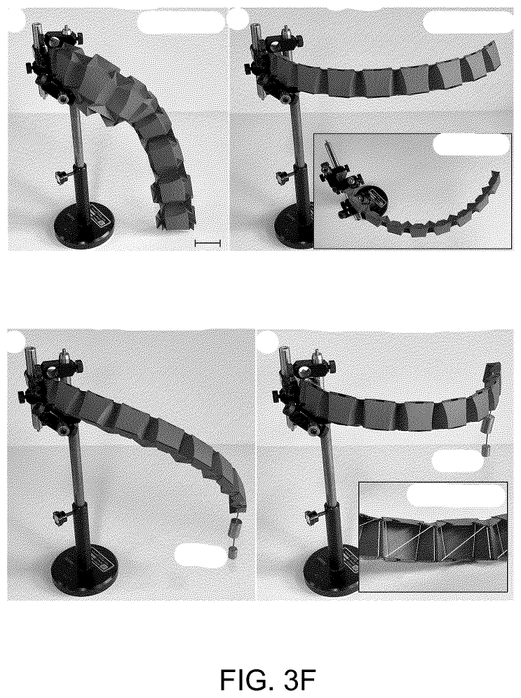

Referring now to FIGS. 3A to 3E, the disclosed cell unit exhibits multi-DOFs before locking. Once locked, it may behave stiff under uniform in-plane compression. However, upon tessellation into a periodic shell, the overall structure's DOFs increase, creating internal mechanisms. In practice, additional non-rigid deformation modes may also emerge due to the panel flexibility. While some origami patterns, such as the lens-box without tendons can limited stiffness or maintain partial rigidity under specific compressive loads and boundary conditions, achieving global rigidity in existing origami tessellations made of compliant panels remains a significant challenge.

Here, it is postulated that the addition of strategically oriented tensile members, namely tendons, to the lens-box units or the doubly curved lens-box units can suppress all DOFs of the system, ensuring multiaxial rigidity regardless of the direction of the applied loads and boundary conditions. Since rigidity under compression is achieved through locking, the added members must only warrant rigidity under tension: a harmony between tensile and compressive members reminiscent of tensegrity structures. As illustrated in FIGS. 3D-3E, these tendons pass through the top-middle and bottom corners of the flat-folded connector units. By stretching the tendons, the partially folded units flex towards their lock state (FIG. 3E). When the connectors flat-fold, the tendons reach their shortest length, and the locked units squeeze their neighboring units. Pre-tension in the tendons acts analogously to applying in-plane pressure on individual building blocks; it enables preserving the integrity of the entire shell structure regardless of any external compressive force.

Referring to FIG. 3F, the addition of tendons may not only prevent deformations arising from multiple rigid folding motions, but may also restrain the non-rigid deformation modes as shown in FIGS. 3B-3C upon strategic tendon arrangement. For example, the paperboard curved structure in FIG. 3F shows zero deflection against a twisting action when rigidified using the tendons, unlike its glued counterpart, which severely deforms under identical conditions. To determine the tendon position and layout illustrated in FIGS. 3D-3F, structural rigidity analysis may be used. The disclosed locked unit may be converted into an equivalent triangulated network of bars and joints. The bottom tendons are self-stressed, a feature advantageous for imparting first-order stiffness to the frame.

The model aims to capture the structural rigidity of the doubly curved lens-box solely in its locked state, where mobility reduces to zero under compression. Here, it is assumed that the bent panels, defined by the ruling segmentation, have zero flexural stiffness, and the rulings are modeled as creases with zero torsional stiffness. This analysis examines the inextensional deformation modes—finite and infinitesimal DOFs—our locked origami may possess. To this end, the following assumptions are made: i) the creases do not bend, following the asymptotic analysis of the Föppl-von Kármán equations which show that, at the thin panel limit, the energy required to bend a strip of straight crease is five times larger than the energy required to stretch it; ii) the connector unit panels in the flat-folded state resist bending due to their four- or eight-layer thickness, making bending energetically less favorable compared to that of single-layer panels in the lens unit.

As shown in FIGS. 3A-3E, a tessellation 300 may include at least one row 301, two rows 301 in this embodiment, of the unit cells 20 extending along a longitudinal axis L0. The unit cells 20 of each of the rows 301 may be interconnected to one another via tendons. Tendons may also be used to interconnect unit cells 20 of one row to unit cells of an adjacent row.

In the embodiment shown, the metamaterial includes a first tendon 351 extending along the longitudinal axis L0 and extending through the connector units 40 of each of the unit cells 20 to maintain the connector units 40 in a folded configuration as described above. The first tendon 351 extends parallel to the symmetry planes P0 of the lens-shaped panels 31 and proximate the lens-shaped panels 31. The first tendon 351 is configured to impart flexural stiffness to the tessellation 300 by opposing a flexion force F1 exerted along a direction transverse to the lens-shape panel 31 of one of the unit cells 20. This force F1 tends to bend the lens-shaped panel 31.

A second tendon 352 may be provided and may interconnect the first distal end 46B to a second distal end 47B of an adjacent connector unit 40. The second tendon 352 is configured to impart one or more of torsional and bending stiffness to the tessellation 300 by opposing one or more of a first torsional moment M1 exerted to the tessellation in a first direction around the longitudinal axis and a force F2 exerted along a direction transverse to the first panel 32 of one of the unit cells 20. The second tendon 352 may extend such as to cross the symmetry plane P0. The second tendon 352 may extend diagonally and non-parallel to the first tendon 351.

In the embodiment shown, a third tendon 353 interconnects the second distal end 47B to a first distal end 46B of the adjacent connector unit 40. The third tendon 353 is configured to impart one or more of torsional and bending stiffness to the tessellation by opposing one or more of a second torsional moment M2 exerted to the tessellation in a second direction opposed to the first direction and a force exerted along a direction transverse to the second panel 33 of one of the unit cells and opposite the force F1 against the first panel 32. The third tendon 353 may extend such as to cross the symmetry plane P0 and extends transversally to the second tendon 352. The third tendon 353 may also extend diagonally and non-parallel to the first tendon 351 and non-parallel to the second tendon 352.

FIG. 3F shows an example of a metamaterial including tendons as described above. As shown, the tendons impart load-bearing capability to the metamaterial, which is able to resist a downward flexion caused by a weight suspended thereto.

### In Situ Tunable Load-Bearing Capacity

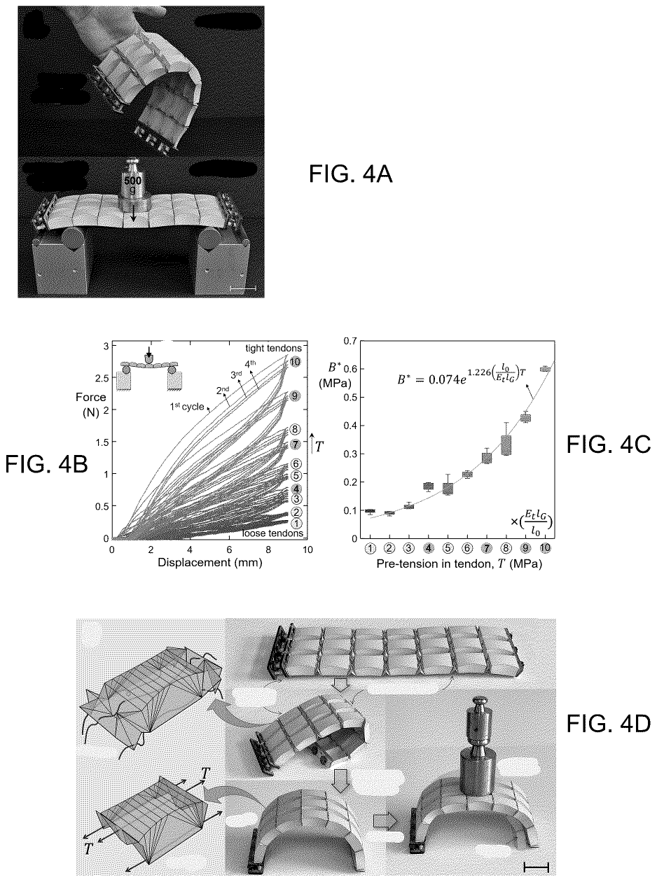

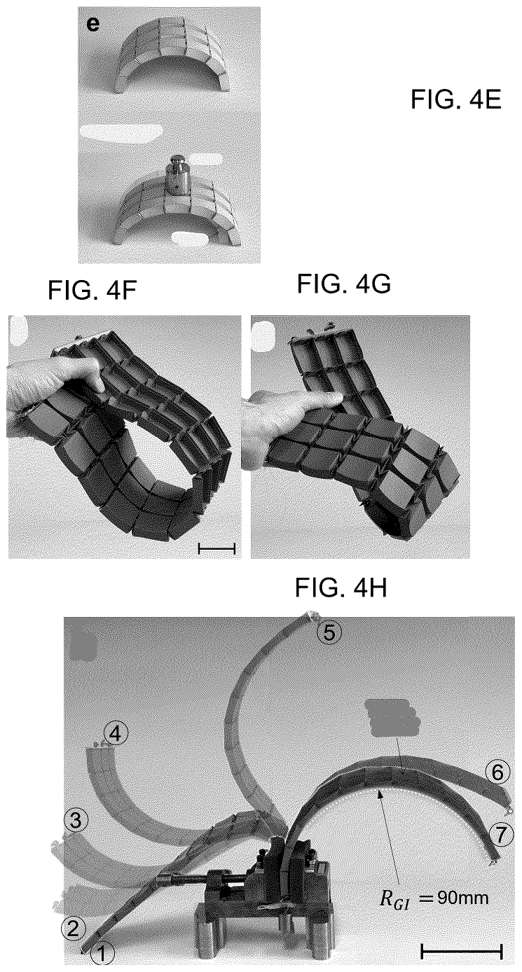

Referring to FIGS. 4A to 4D, to precisely adjust the flexural rigidity of the tendon-origami shells, a one-way rotational gear mechanism designed to stretch individual tendons incrementally may be integrated. By pulling the tendons, the partially folded soft shell gradually reconfigures into its stiff (locked) state with zero-DOF. In this configuration, the tendon-origami shell internally jams, pressing the adjacent building blocks with a force proportional to the tendon stretch (FIG. 4A). This process, which to some extent recalls jamming in granular materials, inhibits rigid and non-rigid deformation modes. While tendons experience stretching, the lens units tolerate compressive loads in harmony, gradually transitioning from a soft to a stiff state. This mode-shift can reversibly, continuously, and quickly enhance the flexural modulus of our tendon-origami shells in operando.

Changes in mechanical properties may be quantified as a function of the tendon pre-tension T by performing a series of three-point bending experiments and calculating the apparent elastic bending modulus B* of the shell (FIG. 4B). Stretching a tendon with initial length l₀ and Young's modulus Eₜ by l_{G} creates the pre-tension T=EₜI_{G}/l₀. If the average stiffness K of the initial elastic regime (FIG. 4B), and the initial planar dimensions L, W, and the thickness

$${h}_{0}^{⋆}$$

of the shell are known, then

$${B}^{*} = \frac{{KL}^{3}}{4 {Wh}_{0}^{{★}^{3}}} .$$

The results in rig. 40 show that by almost linearly increasing the pre-tension, the flexural modulus grows exponentially. The lowest modulus value remained unregistered due to the challenge of measuring the initial tendon length in a formless relaxed state.

FIG. 4D illustrates a paper-based arched deployable shell, exhibiting a remarkable load-to-weight ratio (approximately 162), surpassing that of the glued (rigid) counterpart (see FIG. 4E) by a factor of 4. During actuation, the tendon-origami shell can attain various configurations depending on its initial state and external loads. For instance, FIGS. 4F-4H show the shell actuating under its own weight (14 g), can transition in multiple stable forms before locking into its prescribed load-bearing arc. Tendons enable precise control over the flexible shell kinematics, facilitating a wide range of motions and configurations, particularly suitable for soft robotics applications in constrained environments, e.g., endoscopic surgery. Unlike existing metamaterials with continuously tunable modulus relying on high temperatures, electrical/magnetic fields, or pneumatic pressure—posing risks during use or failure—the disclosed designs may be harmless and safe upon failure and may remain safe and functional even in the event of partial failure. This may be due to the tendon-origami system relies on lockable building blocks with multiple independent tendons, which may enable load redistribution upon failure of a few tendons. As a result, partial failure may not compromise the overall integrity or functionality of the system. In contrast, systems relying on air pressure can fail catastrophically upon puncture, whereas a tendon-origami mechanism remains robust, typically unaffected by the failure of a single tendon, offering a reliable approach for programming stiffness and motion in a robotic system.

### Discussion

So far, it has been shown the necessary conditions and constraints for the smooth folding of the lens unit, the flat foldability of the waterbomb connector units, the attainment of a smooth connection of the lens-box units upon tessellation, and the general rigid foldability of the entire crease pattern. The relations for the individual lens unit and waterbomb connector suggests that the design space of each unit is very rich; an infinite number of lens units may exist that conform into a given surface with constant curvature, and an infinite number of connector units exist that can flat fold for a given geometry of the lens unit. It is therefore plausible that it is possible to find at least one tessellation that exactly matches the first (global) principal curvature of a target surface along the lens panel, i.e., arc-lengths, and well-approximates its second principal (global) curvature.

The metamaterial may thus include a plurality of the unit cells 20 described above, with varying dimensions to achieve many curvature mapping and variations. For instance, the dimension of two adjacent unit cells 20 may vary to conform to a desired shape.

The present disclosure has introduced a hybrid origami tessellation combining straight and curved creases, capable of isometric folding and locking into structural shells with smooth doubly-curved or cylindrical surfaces with varying curvature, thereby addressing the trade-off between flexural rigidity and curvature smoothness in traditional origami tessellations. An inverse design problem whose solutions can generate building blocks for the deployment of load-bearing structures with complex geometries has been explicitly formulated. The integration of tendons may enable the origami shells—unlike existing deployable origami concepts, which are typically compliant or, if lockable, require structural support to tolerate mechanical loads—to transform gradually and reversibly from soft to multiaxially rigid, load-bearing shells with tunable stiffness. Paperboard prototypes confirm the existence of smoothly curved shells and their mechanical characteristics. Demonstrated as rigid-ruling foldable, the discretized, ruled segmentation version of the disclosed patterns can be adapted to non-deformable materials or thick-panel origami.

The formulation and doubly curved lens-box crease pattern described herein can be generalized by breaking the symmetry in the lens unit of the unfolded pattern, which may allow for folding into non-symmetric surfaces with spatially varying Gaussian curvature. Moreover, by orienting the waterbomb units in multiple directions, more complex versions of the lens-unit can be realized, paving the way for a wider variety of generalized doubly curved surfaces. In some embodiments, any structure folded from a developable sheet can only approximate curvature in one direction of a doubly-curved surface with nonzero Gaussian curvature. This is an inherent limitation of using origami to fold flat sheets into doubly-curved surfaces.

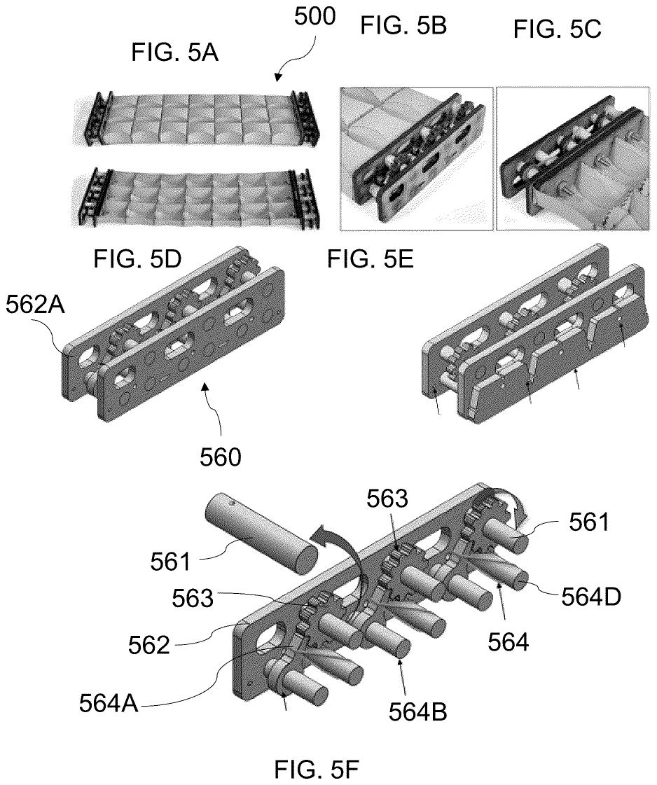

Referring to FIG. 5A to 5F, an exemplary metamaterial is shown at 500 and equipped with a tensioning mechanism 560. This tensioning mechanism 560 is exemplary only since any suitable means to vary the tensions into the tendons described may be used without departing from the scope of the present disclosure.

In the embodiment shown, the tensioning mechanism 560 includes a series of shafts 561 rollingly engage to a base plate 562. The tendons may be wrapped around the shafts 561, which may extend through apertures 562A defined through the base plate 562. The shafts 561 are equipped with gears 563 secured thereto. Stoppers 564 engages the gears 563 to prevent their rotation to prevent the loosening of the tendons. The stoppers 564 may include an arm 564A pivotally mounted to the base plate 562 via a stopper shaft 564B. A biasing member 564C, such as an elastic, is engaged to the arm 564A and secured to the base plate 562, herein via a shank 564D. As illustrated in FIG. 5F, the biasing member 564C biases an end of the stopper arm 564A against one of teeth of the gears 563. To tighten the tendons, the gears 563 may be rotated, herein manually, but actuators, such as motor or else, may be used for this purpose. The rotation of the gears 563 in turn wraps the tendons around the shaft 561 thereby reducing the effective length of the tendons to increase their tension. Loosening of the tendons is prevented by the arms 564A engaging the gears 563. The gears may be rotated individually of one another such that the tension in each of the tendons is independently varied.

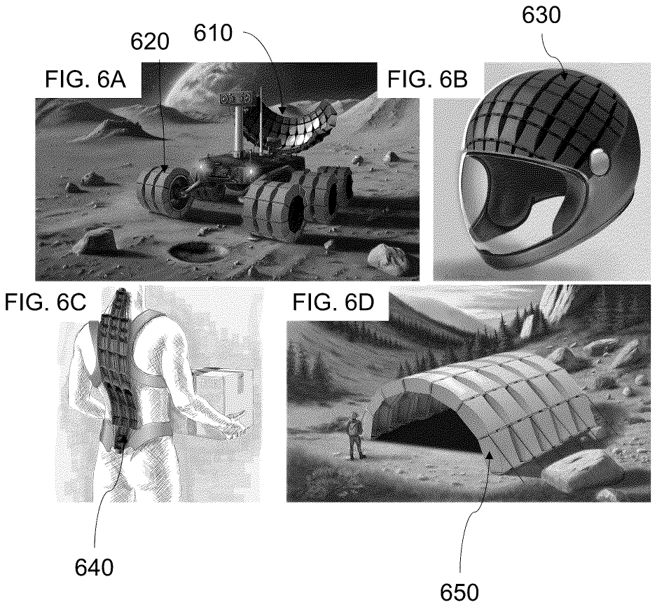

Referring to FIGS. 6A to 6D, a plurality of exemplary structures built using the unit cells described above are illustrated. The design principles—stemming from origami and tensegrity principles—are inherently material-agnostic and scalable enabling the use of various base materials (e.g., metals, polymers, composite carbon fiber sheets) and the scaling of the crease pattern to suit diverse applications, from space missions such as deployable antennas 610 and wheels 620 (FIG. 6A) to safety helmets 630 (FIG. 6B). At larger scales, factors such as material properties, gravitational forces, geometric and material imperfections due to manufacturing might become dominant, influencing mechanical properties and failure mechanisms. By leveraging the synergy between lockable hybrid crease origami and tensegrity notions, the presented approach may open new avenues for the design of deployable and adaptive load-bearing curved structures, including wearable exoskeletons, temporary emergency tents, reconfigurable aerofoils, haptic architectures, morphing robots, and smart fabrics.

Conceptual applications of reconfigurable (and developable) smoothly curved structural shells across various length scales may be envisaged: tunable-stiffness airless tires 620 and high-efficiency doubly curved solar panels 610 eliminating the requirement of a mechanical tracking systems for a futuristic moon rover (FIG. 6A), smoothly doubly curved protective helmet 630 (FIG. 6B), ergonomic tendon-driven adaptive exoskeletons 640 (FIG. 6C) with enhanced comfort and functionality, and lightweight, meter-scale temporary emergency tents 650 (FIG. 6D) that are aerodynamically efficient and structurally sound.

### Method

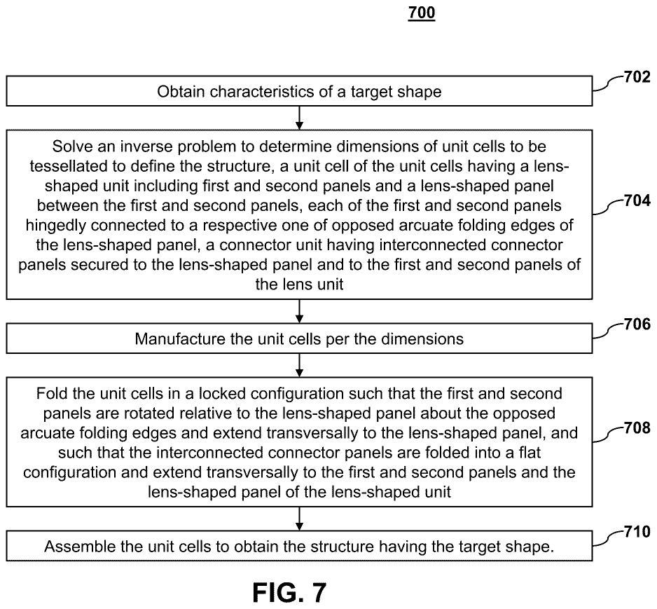

Referring now to FIG. 7, a method of manufacturing a structure using interconnected unit cells as described above is shown at 700. The method 700 includes obtaining characteristics of a target shape at 702; solving an inverse problem to determine dimensions of unit cells to be tessellated to define the structure, a unit cell of the unit cells having a lens-shaped unit including first and second panels and a lens-shaped panel between the first and second panels, each of the first and second panels hingedly connected to a respective one of opposed arcuate folding edges of the lens-shaped panel, a connector unit having interconnected connector panels secured to the lens-shaped panel and to the first and second panels of the lens unit at 704; manufacturing the unit cells per the dimensions at 706; folding the unit cells in a locked configuration such that the first and second panels are rotated relative to the lens-shaped panel about the opposed arcuate folding edges and extend transversally to the lens-shaped panel, and such that the interconnected connector panels are folded into a flat configuration and extend transversally to the first and second panels and the lens-shaped panel of the lens-shaped unit at 708; and assembling the unit cells to obtain the structure having the target shape at 710.

In some embodiments, the solving of the inverse problem to determine the dimensions of the unit cells at 704 include determining lengths of the arcuate folding edges.

In some embodiments, the assembling of the unit cells at 710 includes interconnecting the unit cells with tendons to impart one or more of flexural stiffness and torsional stiffness.

### CONCLUSIONS

This work has introduced a hybrid origami tessellation using straight and curved creases capable of isometric folding and conforming to structural shells with smooth doubly-curved or cylindrical surfaces upon locking. It has been explicitly formulated an inverse design problem whose solutions can generate building blocks for the deployment of load-bearing structures with complex geometries. The integration of tendons has enabled our origami shells to transform gradually and reversibly from soft to rigid load-bearing shells with tunable stiffness. Demonstrated as rigid-foldable, our patterns can be adapted to non-deformable materials. Paperboard prototypes confirm the existence of smoothly curved shells and their mechanical characteristics. By leveraging the synergy between lockable hybrid crease origami and tensegrity notions, our approach opens new avenues for the design of deployable load-bearing curved structures, wearable exoskeletons, reconfigurable aerofoils, haptic architectures, morphing robots, and smart fabrics.

It is noted that various connections are set forth between elements in the preceding description and in the drawings. It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities. The term “connected” or “coupled to” may therefore include both direct coupling (in which two elements that are coupled to each other contact each other) and indirect coupling (in which at least one additional element is located between the two elements).

It is further noted that various method or process steps for embodiments of the present disclosure are described in the preceding description and drawings. The description may present the method and/or process steps as a particular sequence. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the description should not be construed as a limitation.

Furthermore, no element, component, or method step in the present disclosure is intended to be dedicated to the public regardless of whether the element, component, or method step is explicitly recited in the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various aspects of the present disclosure have been disclosed, it will be apparent to those of ordinary skill in the art that many more embodiments and implementations are possible within the scope of the present disclosure. For example, the present disclosure as described herein includes several aspects and embodiments that include particular features. Although these particular features may be described individually, it is within the scope of the present disclosure that some or all of these features may be combined with any one of the aspects and remain within the scope of the present disclosure. References to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. The use of the indefinite article “a” as used herein with reference to a particular element is intended to encompass “one or more” such elements, and similarly the use of the definite article “the” in reference to a particular element is not intended to exclude the possibility that multiple of such elements may be present.

The embodiments described in this document provide non-limiting examples of possible implementations of the present technology. Upon review of the present disclosure, a person of ordinary skill in the art will recognize that changes may be made to the embodiments described herein without departing from the scope of the present technology. Yet further modifications could be implemented by a person of ordinary skill in the art in view of the present disclosure, which modifications would be within the scope of the present technology.

1. A structure, comprising:
a tessellation of unit cells secured to one another, a unit cell of the unit cells including:
a lens-shaped unit having first and second panels and a lens-shaped panel between the first and second panels, each of the first and second panels hingedly connected to a respective one of opposed arcuate folding edges of the lens-shaped panel; and
a connector unit having interconnected connector panels secured to the lens-shaped panel and to the first and second panels of the lens unit,
wherein the unit cell has:
an unfolded configuration in which the lens-shaped unit and the connector unit lie in a common plane, and
a locked configuration in which the first and second panels are rotated relative to the lens-shaped panel about the opposed arcuate folding edges and extend transversally to the lens-shaped panel, and in which the interconnected connector panels are folded into a flat configuration and extend transversally to the first and second panels and the lens-shaped panel of the lens-shaped unit.

2. The structure of claim 1, wherein the connector unit is a waterbomb connector.

3. The structure of claim 1, wherein the lens panel defines two symmetry plane being normal to one another.

4. The structure of claim 1, wherein the lens-shaped unit folds symmetrically with respect to a symmetry plane of the lens-shaped panel such that the first panel faces the second panel.

5. The structure of claim 1, wherein the tessellation of the unit cells includes at least one row of the unit cells extending along a longitudinal axis.

6. The structure of claim 5, comprising tendons interconnecting the unit cells and maintaining the unit cells in the locked configuration.

7. The structure of claim 6, wherein the tendons include a first tendon interconnecting together all of the connectors units to maintain the connector units in a folded configuration, the first tendon configured to impart flexural stiffness to the tessellation by opposing a flexion force exerted along a direction transverse to the lens-shape panel of one of the unit cells.

8. The structure of claim 7, wherein the first tendon extends along the longitudinal axis and through the connector units, the first tendon extending along symmetry planes of the lens-shaped panels and proximate the lens-shaped panels.

9. The structure of claim 7, wherein, in the locked configuration, the tessellation defines boxes having an opening defined by the first and second panels of the lens unit and by connector units, the structure further comprising:
a second tendon that extends diagonally across the opening and that interconnect a first connector unit to a second connector unit, the second tendon configured to impart one or more of torsional and bending stiffness to the tessellation by opposing one or more of a first torsional moment exerted to the tessellation in a first direction around the longitudinal axis and a force exerted along a direction transverse to the first panel of one of the unit cells.

10. The structure of claim 9, comprising:
a third tendon that extends diagonally across the opening and transversally to the second tendon, the third tendon interconnecting the first connector unit to the second connector unit, the third tendon configured to impart one or more of torsional and bending stiffness to the tessellation by opposing one or more of a second torsional moment exerted to the tessellation in a second direction opposed to the first direction and a force exerted along a direction transverse to the second panel of one of the unit cells.

11. The structure of claim 10, wherein the connector unit is connected to the lens-shaped panel via a lens edge, to the first panel via a first edge, and to the second panel via a second edge, the first edge extending from a first proximal end at a first intersection with the lens-shaped panel to a first distal end, the second edge extending from a second proximal end at a second intersection with the lens-shaped panel to a second distal end, the second tendon interconnecting the first distal end to a second distal end of an adjacent connector unit.

12. The structure of claim 11, wherein the third tendon interconnects the second distal end to a first distal end of the adjacent connector unit.

13. The structure of claim 1, wherein the lens panel defines a single symmetry plane, the first and second panels located on respective opposite sides of the single symmetry plane.

14. The structure of claim 13, wherein the unit cells include a first unit cell and a second unit cell, a first area covered by the first unit cell different than a second area covered by the second unit cell.

15. The structure of claim 13, wherein the tessellation, in the locked configuration, defines a doubly-curved surface, the doubly-curved surface defining a curvature in two directions perpendicular to one another.

16. The structure of claim 12, comprising a tensioning mechanisms to impart tension in the tendons.

17. The structure of claim 1, wherein the structure is one of a wheel, an antenna, a helmet, an exoskeleton, and a tent.

18. A method of manufacturing a structure using interconnected unit cells, comprising:
obtaining characteristics of a target shape;
solving an inverse problem to determine dimensions of unit cells to be tessellated to define the structure, a unit cell of the unit cells having a lens-shaped unit including first and second panels and a lens-shaped panel between the first and second panels, each of the first and second panels hingedly connected to a respective one of opposed arcuate folding edges of the lens-shaped panel, a connector unit having interconnected connector panels secured to the lens-shaped panel and to the first and second panels of the lens unit;
manufacturing the unit cells per the dimensions;
folding the unit cells in a locked configuration such that the first and second panels are rotated relative to the lens-shaped panel about the opposed arcuate folding edges and extend transversally to the lens-shaped panel, and such that the interconnected connector panels are folded into a flat configuration and extend transversally to the first and second panels and the lens-shaped panel of the lens-shaped unit; and
assembling the unit cells to obtain the structure having the target shape.

19. The method of claim 18, wherein the solving of the inverse problem to determine the dimensions of the unit cells include determining lengths of the arcuate folding edges.

20. The method of claim 18, wherein the assembly of the unit cells includes interconnect the unit cells with tendons to impart one or more of flexural stiffness and torsional stiffness.
